(19) United States
(12) Patent Application Publication
(10) Pub. No.: US 2009/0144766 A1
(43) Pub. Date: Jun. 4, 2009

(54) METHOD AND APPARATUS FOR MULTI-STREAM PROCESSING OF SET TOP BOX IN DOWNLOADABLE CONDITIONAL ACCESS SYSTEM

(76) Inventors: Joon Young JUNG, Daejeon (KR); O Hyung KWON, Daejeon (KR); Soo In LEE, Daejeon (KR)

Correspondence Address: LADAS & PARRY LLP, 224 SOUTH MICHIGAN AVENUE, SUITE 1600, CHICAGO, IL, 60604, US

(21) Appl. No.: 12/326,955

(22) Filed: Dec. 3, 2008

(30) Foreign Application Priority Data
Dec. 4, 2007 (KR) 10-2007-0125145

(51) Int. Cl. H04N 7/167; H04N 7/173

(52) U.S. Cl. 725/31; 725/132; 725/111

(57) ABSTRACT

A multi-stream processing apparatus of a set top box in a Downloadable Conditional Access System (DCAS), the apparatus including: a cable modem (CM) to allocate at least one communication channel with respect to a headend of a broadcasting company connected with a cable network; a demodulator to receive broadcasting information from the cable network using the at least one allocated communication channel and to demodulate the received broadcasting information; a security module to descramble the demodulated broadcasting information using an application downloaded from the headend of the broadcasting company; a decoder to restore the descrambled broadcasting information into an Audio/Video (A/V) signal and to transmit the A/V signal to a connected apparatus; and a software module to control the CM, the security module, the demodulator, and the decoder, and to perform routing of information.

### CROSS-REFERENCE TO RELATED APPLICATION

This application claims priority from Korean Patent Application No. 10-2007-0125145, filed on Dec. 4, 2007, in the Korean Intellectual Property Office, the entire disclosure of which is incorporated herein by reference.

### BACKGROUND OF THE INVENTION

1. Field of the Invention

The present invention relates to a multi-stream processing method and apparatus of a set top box in a Downloadable Conditional Access System (DCAS), and more particularly, to a multi-stream processing method and apparatus which enables the set top box supporting the DCAS in a cable broadcasting system to simultaneously process a plurality of fee-based channels.

This work was supported by the IT R&D program of MIC/IITA [2007-S-007-01, The Development of Downloadable Conditional Access System].

2. Description of Related Art

A Conditional Access System (CAS) provides an authority for only subscribed clients (members) to watch fee-based contents by encrypting a broadcasting program, which is indispensable to a fee-based broadcasting such as cable broadcasting and satellite broadcasting. In a CAS, a CA application is essential to encrypt/decrypt a key required for scrambling/descrambling fee-based contents.

A Downloadable Conditional Access System (DCAS) having been recently promoted for North American cable broadcasting firms is disclosed to eliminate a receiver cost problem, member inconvenience, and the like from an existing CAS, and is quickly being developed by various service providers and equipment manufacturers.

In order to provide a fee-based broadcasting service in current domestic and North American digital cable broadcasting, a cable card in either a smart card form or a Personal Computer Memory Card International Association (PCMCIA) card form is generally used depending on an embodiment form of a Conditional Access (CA) application of a set top box. The fee-based broadcasting is made viewable by distributing CA software (S/W) (a CA client image) offline using either a smart card or a PCMCIA card, and installing the CA S/W in the set top box.

However, since this method requires a predetermined amount of time for card reissuance when a defect in the CAS occurs, quick analysis with respect to the defect is difficult, and an additional cost due to card reissuance is required.

A multi-screen application of simultaneously processing a plurality of channels in addition to a function of simply processing broadcasting data, such as a Picture In Picture (PIP) and Picture Out Picture (POP), a Digital Video Recorder (DVR) application of recording a channel program and watching the channel program at a convenient time while watching another channel program, and the like are provided in a recent set top box.

Accordingly, multi-stream processing is required for a security module installed for supporting a multi-channel processing application in the set top box in the DCAS.

The security module to be installed in the set top box is generally classified into two processors, a Secure Micro (SM) to download and drive the CA application, and a Transport Processor (TP) to descramble and restore a fee-based broadcasting program scrambled by control of the SM.

In particular, a function of multiplexing the plurality of channels in the TP, descrambling the plurality of channels, demultiplexing the plurality of channels again, and outputting the plurality of channels is essentially required in order to simultaneously process a plurality of fee-based broadcasting channels.

### SUMMARY OF THE INVENTION

An aspect of the present invention provides a multi-stream processing method and apparatus of a set top box in a Downloadable Conditional Access System (DCAS) which enables the set top box supporting the DCAS in a cable broadcasting system to simultaneously process a plurality of fee-based channels.

Another aspect of the present invention also provides a multi-stream processing method using a security module installed in a set top box.

Another aspect of the present invention also provides a multi-stream processing method and apparatus of a set top box in a DCAS which can multiplex a plurality of channels inputted for supporting a multi-channel processing application, generate a single multi-stream, demultiplex the processed multi-stream, and output the demultiplexed multi-stream to each channel in addition to a function of descrambling and restoring broadcasting information using a Transport Processor (TP).

According to an aspect of the present invention, there is provided a multi-stream processing apparatus of a set top box in a DCAS, the apparatus including: a cable modem (CM) to allocate at least one communication channel with respect to a headend of a broadcasting company connected with a cable network; a demodulator to receive broadcasting information from the cable network using the at least one allocated communication channel and to demodulate the received broadcasting information; a security module to descramble the demodulated broadcasting information using an application downloaded from the headend of the broadcasting company; a decoder to restore the descrambled broadcasting information into an Audio/Video (A/V) signal and to transmit the A/V signal to a connected apparatus; and a software module to control the CM, the security module, the demodulator, and the decoder, and to perform routing of information.

In an aspect of the present invention, the security module includes: a TP module to descramble the demodulated broadcasting information using the downloaded application; and a Secure Micro (SM) module to provide the TP module with at least one of descrambling key information, a scrambling algorithm, and initialization information.

In an aspect of the present invention, the TP module includes: a multiplexer to multiplex the single stream being at least one piece of the broadcasting information received using at least one communication channel into the multi-stream; a broadcasting information filter to receive and filter the multi-stream; a key memory to store key information used for descrambling the filtered multi-stream; at least one descrambler to descramble the filtered multi-stream using the key information; and a demultiplexer to demultiplex the descrambled multi-stream and to output the demultiplexed multi-stream to the at least one communication channel.

In an aspect of the present invention, the multiplexer multiplexes at least one received stream using a pre-header attachment scheme, and the demultiplexer demultiplexes the descrambled multi-stream using a Packet Clock Reference (PCR) correction scheme.

According to another aspect of the present invention, there is provided a multi-stream processing method of a set top box in a DCAS, the method including: allocating at least one communication channel with respect to a headend of a broadcasting company connected with a cable network; performing an authentication process with respect to the headend using the at least one allocated communication channel; downloading an application from the headend when the authentication process is completed; receiving broadcasting information from the cable network using the at least one allocated communication channel and demodulating the received broadcasting information; descrambling the demodulated broadcasting information using the application downloaded from the headend of the broadcasting company; and restoring the descrambled broadcasting information into an A/V signal and transmitting the A/V signal to a connected apparatus.

In an aspect of the present invention, the descrambling includes: multiplexing a stream being at least one piece of the broadcasting information received using the at least one communication channel into a multi-stream; receiving and filtering the multi-stream; storing key information used for descrambling the filtered multi-stream; descrambling the filtered multi-stream using the key information; and demultiplexing the descrambled multi-stream and outputting the demultiplexed multi-stream to the at least one communication channel.

### BRIEF DESCRIPTION OF THE DRAWINGS

The above and other aspects of the present invention will become apparent and more readily appreciated from the following detailed description of certain exemplary embodiments of the invention, taken in conjunction with the accompanying drawings of which:

FIG. 1 is a block diagram illustrating a multi-stream processing apparatus of a set top box in a Downloadable Conditional Access System (DCAS) according to an exemplary embodiment of the present invention;

FIG. 2 is a block diagram illustrating a Transport Processor (TP) module of FIG. 1;

FIG. 3 illustrates a structure of a pre-header according to an exemplary embodiment of the present invention;

FIG. 4 illustrates a structure of a key memory of FIG. 2;

FIG. 5 is a block diagram illustrating a detailed structure of a multiplexer of FIG. 2;

FIG. 6 is a block diagram illustrating a detailed structure of a demultiplexer of FIG. 2;

FIG. 7 is a flowchart illustrating a multi-stream processing method of a set top box in a DCAS according to an exemplary embodiment of the present invention; and

FIG. 8 is a flowchart illustrating a descrambling method according to an exemplary embodiment of the present invention.

### DETAILED DESCRIPTION OF EXEMPLARY EMBODIMENTS

Reference will now be made in detail to exemplary embodiments of the present invention, examples of which are illustrated in the accompanying drawings, wherein like reference numerals refer to the like elements throughout. The exemplary embodiments are described below in order to explain the present invention by referring to the figures.

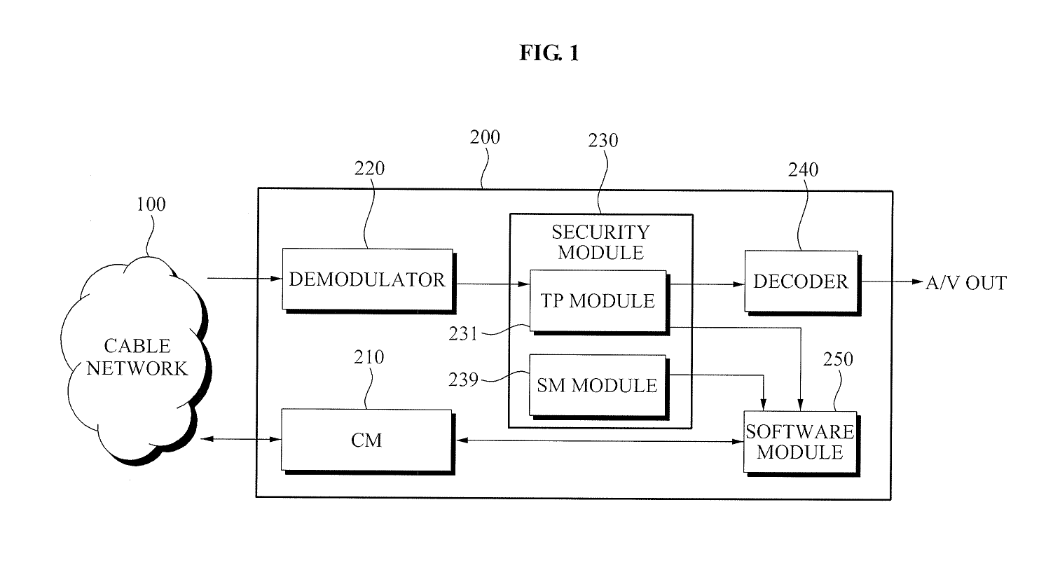

FIG. 1 is a block diagram illustrating a multi-stream processing apparatus 200 of a set top box in a Downloadable Conditional Access System (DCAS) according to an exemplary embodiment of the present invention.

The DCAS according to an exemplary embodiment of the present invention includes a technology of installing a security module in which a software module (Conditional Access (CA) software is used as an example in an exemplary embodiment of the present invention) is installed in the set top box, downloading software using a cable network, and easily updating the software in a situation such as when a defect in security of the software occurs or when updating a software version.

Since a security module chip installed in the set top box according to an exemplary embodiment of the present invention has a general-purpose structure to process a plurality of Conditional Access Systems (CASs), a cable enterprise may select a CAS enterprise without being dependent on a specific CAS solution, and may provide various services.

The multi-stream processing apparatus 200 according to an exemplary embodiment of the present invention provides a method of multiplexing a plurality of channels inputted for supporting a multi-channel processing application, generating a single multi-stream, demultiplexing the processed multi-stream, and outputting the demultiplexed multi-stream to each channel, and a configuration of the multi-stream processing apparatus 200 according to an exemplary embodiment of the present invention is sequentially described corresponding to the method.

First, a cable modem (CM) 210 allocates at least one communication channel with respect to a headend of a broadcasting company connected with a cable network 100.

In this instance, a demodulator 220 receives broadcasting information from the cable network 100 using the at least one allocated communication channel and demodulates the received broadcasting information.

The security module 230 subsequently descrambles the demodulated broadcasting information using an application downloaded from the headend of the broadcasting company.

In this instance, the security module 230 performs an authentication process with respect to the headend using the at least one allocated communication channel before descrambling the broadcasting information.

The security module 230 according to an exemplary embodiment of the present invention downloads the application from the headend when the authentication process is completed, and descrambles the broadcasting information using the downloaded application, for example, a CA application. This is described in detail below.

The security module 230 includes a Transport Processor (TP) module 231 to descramble the demodulated broadcasting information using the downloaded application, and a Secure Micro (SM) module 239 to provide the TP module 231 with at least one of descrambling key information, a scrambling algorithm, and initialization information.

When an exemplary embodiment of the present invention is connected with the cable network 100, the SM module 239 performs the authentication process of the security module 230, and the authentication process is performed with the SM module 239 of the multi-stream processing apparatus 200 and an Authentication Proxy (AP) server included in the headend of the broadcasting company.

As described above, the CM 210 according to an exemplary embodiment of the present invention provides the communication channel with the headend, and a software module 250 with built-in DCAS software according to an exemplary embodiment of the present invention transceives a related message from/to the SM module 239.

The software module 250 controls the CM 210, the security module 230, the demodulator 220, and a decoder 240, and performs routing of information.

As described above, the application driven in the SM module 239 provides key information required for descrambling the broadcasting information by the TP module 231, a scrambling scheme, the initialization information, and the like, and enables the TP module 231 to perform descrambling.

Finally, the decoder 240 restores the descrambled broadcasting information into an Audio/Video (A/V) signal and transmits the A/V signal to a connected apparatus. A user using an exemplary embodiment of the present invention may receive the signal using a predetermined terminal and perform pay-per-view.

An exemplary embodiment of the present invention includes a function of multiplexing the plurality of channels into a single stream and a function of demultiplexing the descrambled stream into each channel again in addition to a basic descrambling function in the TP module 231.

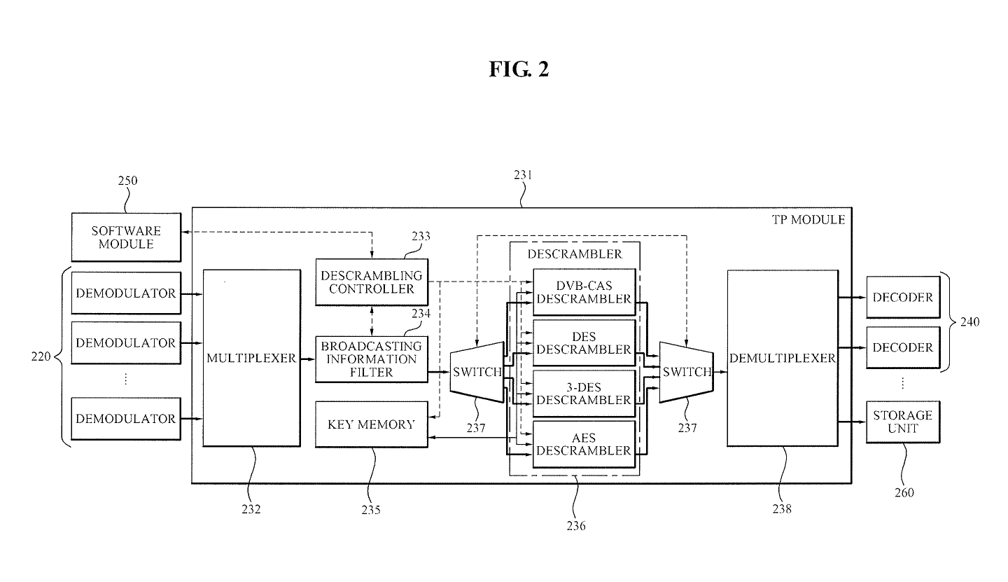

FIG. 2 is a block diagram illustrating the TP module 231 of FIG. 1.

As described above, an exemplary embodiment of the present invention includes various functions, and a method of performing a descrambling function using a configuration of the TP module 231 of the security module 230 from among the various functions is described in detail below with reference to FIG. 2.

When descrambling initialization information is inputted into the software module 250 in the SM module 239 according to an exemplary embodiment of the present invention, the software module 250 transmits the initialization information to a descrambling controller 233 of the TP module 231.

The descrambling controller 233 having received the descrambling initialization information subsequently analyzes the information, determines which descrambler 236 is used, and initializes the corresponding descrambler 236.

The descrambler 236 according to an exemplary embodiment of the present invention includes a plurality of descramblers 236 in order to support various descrambling functions. For example, there are a Digital Video Broadcasting-Common Scrambling Algorithm (DVB-CSA) descrambler to support a DVB-CSA, a Data Encryption Standard (DES) descrambler to support a DES, a 3-DES descrambler to support a Triple-DES, an Advanced Encryption Standard (AES) descrambler to support an AES, and the like.

Including the plurality of descramblers 236 in the TP module 231 as described above is intended for a general-purpose use without being limited to a specific CAS. This results from a general fact that each CAS may respectively and differently use a scrambling algorithm used for a corresponding system.

The descrambling controller 233 of the TP module 231 respectively controls a multiplexer 232, a broadcasting information filter 234, a key memory 235, the descrambler 236, and a demultiplexer 238 being each component of the TP module 231 described below, transceives information, a control message, and the like using communication with the software module 250, and transmits an entire control command of the multi-stream processing apparatus 200.

Since the multiplexer 232 is connected with the cable network 100, the multiplexer 232 receives at least one piece of the broadcasting information received using a plurality of communication channels, and multiplexes a stream of the broadcasting information into the multi-stream.

The multiplexer 232 according to an exemplary embodiment of the present invention receives a Motion Picture Experts Group (MPEG)-2 Transport Stream (TS) being one of streams of the broadcasting information outputted by at least one demodulator 220.

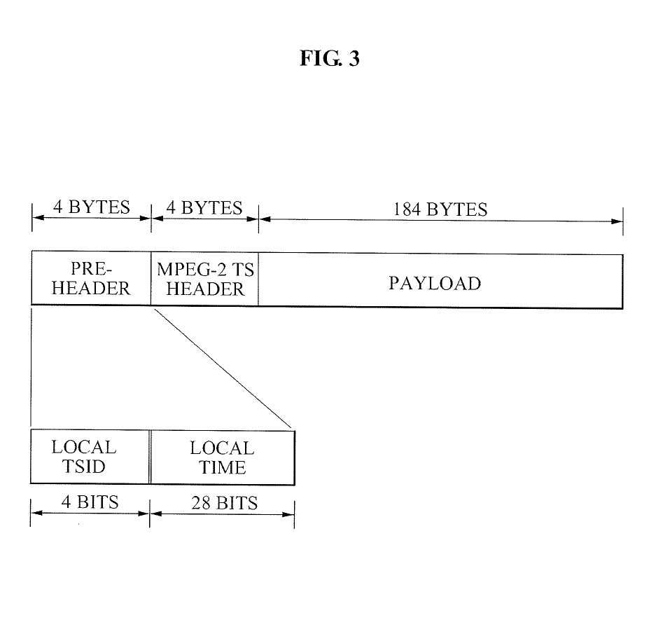

FIG. 3 illustrates a structure of a pre-header according to an exemplary embodiment of the present invention.

As illustrated in FIG. 3, an exemplary embodiment of the present invention provides a method of inserting the pre-header of four bytes before MPEG TS packets of 188 bytes in each stream in order to correct jitter of a Packet Clock Reference (PCR) due to classifying and multiplexing each channel stream as an exemplary embodiment of a multiplexing process, however, the present invention is not limited to the method.

The broadcasting information filter 234 receives and filters the multi-stream.

The multi-stream includes various broadcasting-related information. For example, the multi-stream includes MPEG-2 program-related information, and the broadcasting-related information includes a Program Specific Information (PSI) table being a specific program information table.

The specific program information table includes a TS packet. When the broadcasting-related information is filtered, the specific program information table may appropriately adjust the broadcasting-related information applying correspondingly to the packet, and filter the broadcasting-related information.

In the present invention, an exemplary embodiment of the broadcasting information filter 234 may be an MPEG-2 TS filter, and the broadcasting information filter 234 receives the multiplexed multi-stream and outputs the multiplexed multi-stream as it is. The broadcasting information filter 234 detects the TS packet including the PSI table for each channel and an Entitlement Control Message (ECM), and outputs the copy of the TS packet to the descrambling controller 233.

According to a TS packet filtering sequence, each channel is first classified using the pre-header, a packet having a Program Associate Table (PAT) of a corresponding channel, that is, a packet in which a Packet Identification (PID) of an MPEG-2 TS header is 0, is filtered and is transmitted to the descrambling controller 233.

The descrambling controller 233 extracts PID information about Program Map Tables (PMTs) from the PAT of the corresponding channel, and transmits the PID information to the broadcasting information filter 234. The broadcasting information filter 234 having received the PID information filters the packet including the PMT using the received PID information, and transmits the packet to the descrambling controller 233.

The descrambling controller 233 having received the PMTs of the corresponding channel extracts the PID information of an ECM packet from the PMTs, and transmits the PID information to the broadcasting information filter 234 again. The broadcasting information filter 234 filters the packet including the ECM and transmits the packet to the descrambling controller 233 using the above-described process.

The descrambling controller 233 having received the ECM packet transmits the ECM packet to the software module 250, and the software module 250 transmits the ECM packet to the SM module 239 again.

The SM module 239 having received the ECM analyzes the ECM, extracts key information used for descrambling, and transmits the key information to the descrambling controller 233 using the software module 250.

The descrambling controller 233 having received descrambling key information stores the descrambling key information in the key memory 235.

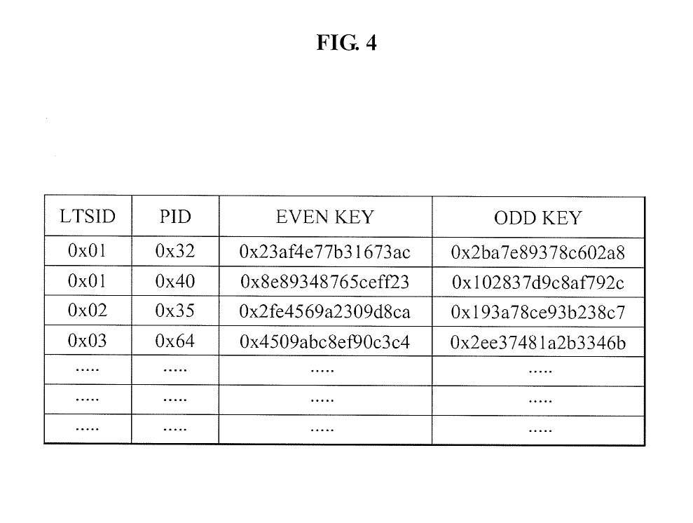

FIG. 4 illustrates a structure of the key memory 235 of FIG. 2.

As illustrated in FIG. 4, the key memory 235 classifies key information used for descrambling of the filtered multi-stream into information including a channel, a PID, an even/odd key, and the like, and stores the key information.

The switch 237 transmits the multi-stream from the broadcasting information filter 234 to any one of the at least one descrambler 236, and subsequently transmits the descrambled multi-stream from the selected descrambler 236 to the demultiplexer 238.

The descrambler 236 subsequently descrambles the filtered multi-stream using the key information.

The multi-stream outputted by the broadcasting information filter 234 is inputted to any one of the at least one descrambler 236, for example, a DVB-CSA descrambler, using a path set in the switch 237, and the DVB-CSA descrambler extracts channel information of a pre-header with respect to each packet of the multi-stream, PID information of a TS header, and a Scrambling_Control field value, reads corresponding key information in the key memory 234, and performs descrambling.

Finally, the demultiplexer 238 demultiplexes the descrambled multi-stream and outputs the demultiplexed multi-stream to the at least one communication channel.

The descrambled multi-stream is inputted in the demultiplexer 238 using the switch 237, and each packet of the inputted multi-stream is demultiplexed to a corresponding channel using the channel information of the pre-header.

An exemplary embodiment of the present invention may find a TS packet including PCR information using timing information in the pre-header during a demultiplexing process, correct PCR jitter, and finally eject and output the pre-header.

Each demultiplexed channel stream is restored into an A/V signal by the decoder 240 using a corresponding path, or is stored in a storage unit 260 such as a hard disk drive.

An exemplary embodiment of the present invention provides a method of multiplexing broadcasting information received using a plurality of communication channels into a single multi-stream, and this is a characteristic factor of an exemplary embodiment of the present invention. As described above, the method of multiplexing the broadcasting information into the multi-stream according to an exemplary embodiment of the present invention is described in detail below.

As illustrated in FIG. 3, a 4-byte pre-header provided by an exemplary embodiment of the present invention is classified into a 4-bit local Transport Stream ID (TSID) and a 28-bit local time field.

The local TSID is a field for classifying which channel packet corresponds to each packet in a stream even when each channel stream is multiplexed into the single multi-stream, and counter values of using an MPEG clock of 27 MHz, that is, the counter values of attaching the pre-header in the multiplexer 232 of FIG. 2 are recorded in the local time field.

The recorded values are used for correcting the PCR jitter in the demultiplexer 238, and the demultiplexer 238 receives the counter values generated by the multiplexer 232.

When a TS packet including PCR is retrieved in the demultiplexer 238, an exemplary embodiment of the present invention records a local time field value of the pre-header and a current counter value, and finds and compares differences of the local time field value of the pre-header in a PCR packet being subsequently retrieved and a counter value in this instance, and each previously-retrieved value.

When a difference of local time field values and a difference of counter values are different from each other, jitter occurs. Therefore, an exemplary embodiment of the present invention finds a difference with respect to a local time difference and the difference of counter values again, and corrects a PCR value using the difference.

The key memory 235 includes a Local TSID (LTSID) field, a PID field, an even key field, and an odd key field. When the inputted TS packet is scrambled, each descrambler 236 in the TP module 231 extracts an LTSID of a packet, a PID, and even/odd key information, and reads a corresponding key in the key memory 235.

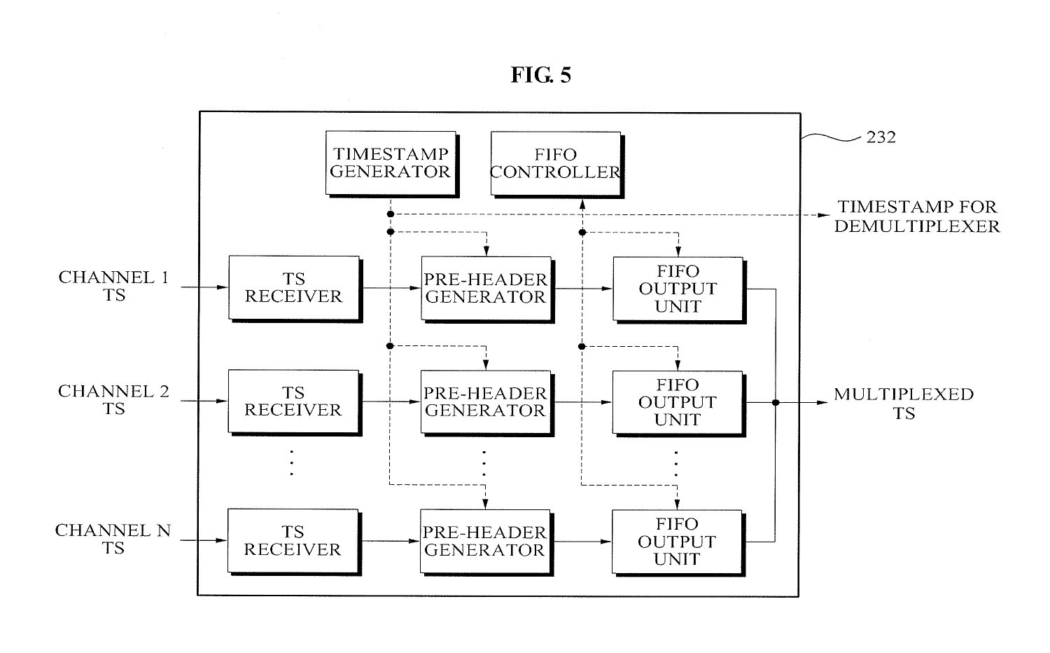

FIG. 5 is a block diagram illustrating a detailed structure of the multiplexer 232 of FIG. 2.

A method of multiplexing a stream using the multiplexer 232 according to an exemplary embodiment of the present invention is described in detail with reference to FIG. 5, however, following contents provides an exemplary embodiment of the present invention, and the present invention is not limited to the following contents.

When a broadcasting stream of channels selected by a member is inputted to a TS receiver of the multiplexer 232, the broadcasting stream is synchronized with a required operation clock and is outputted as a data block form of an MPEG-2 TS packet (188 bytes) again.

Each TS packet passed in the TS receiver is attached to a 4-byte pre-header in each pre-header generator, and is outputted as a 192-byte packet form.

A timestamp value is provided for a local time field of the pre-header from a timestamp generator (a local timestamp generator). The timestamp generator includes a 28-bit counter and operates based on 27 MHz being an MPEG reference clock.

The generated timestamp (counter) value is transmitted to be used for the demultiplexer 238, and each 192-byte packet outputted by the pre-header generator is finally outputted based on a sequence after each 192-byte packet is inputted in a First In First Out (FIFO) output unit.

A control signal is received from an FIFO controller and is outputted so that the packet outputted by the FIFO output unit may not collide with each other. Each FIFO output unit transmits a byte number of currently-stored data to the FIFO controller for each clock, and the FIFO controller first transmits a signal of commanding to output the byte number to the FIFO output unit storing 192 bytes, verifies whether a byte number stored by another FIFO output unit is greater than or equal to 192 after a 192nd clock passes, and transmits the signal of commanding to output the byte number to a subsequent FIFO output unit.

Using the above-described process, collision of packets outputted by each FIFO output unit may be prevented.

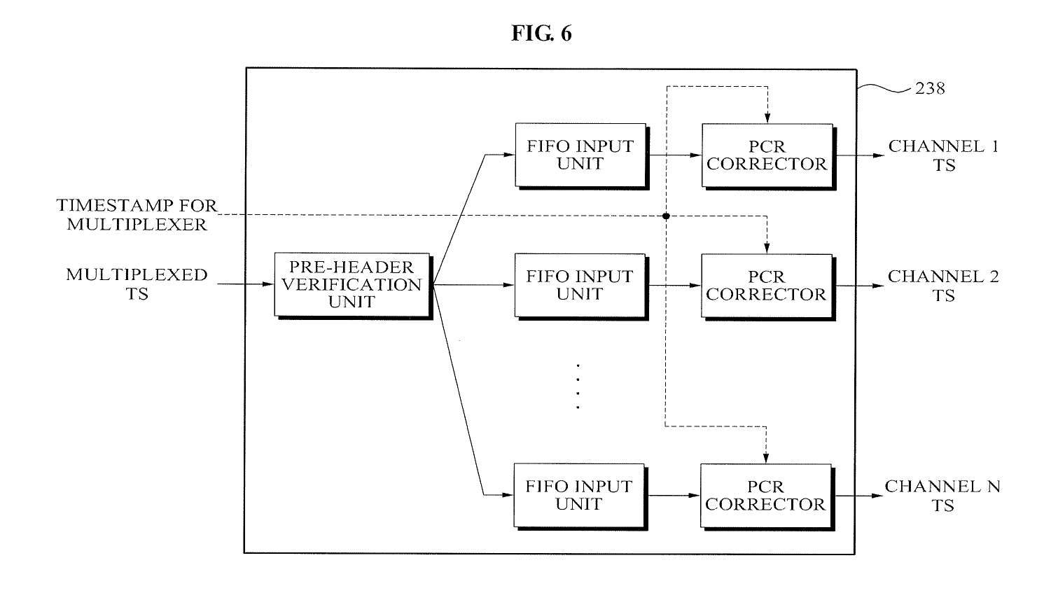

FIG. 6 is a block diagram illustrating a detailed structure of the demultiplexer 238 of FIG. 2.

An exemplary embodiment of the present invention provides a method of demultiplexing, using the demultiplexer 238, a stream multiplexed into a multi-stream by the multiplexer 232, and this is a characteristic factor of an exemplary embodiment of the present invention. As described above, the method of demultiplexing the multi-stream according to an exemplary embodiment of the present invention is described in detail below.

The method of demultiplexing the multi-stream using the demultiplexer 238 according to an exemplary embodiment of the present invention is described in detail with reference to FIG. 6, however, the following contents provides merely an exemplary embodiment of the present invention, and the present invention is not limited to the following contents.

When a TS descrambled by the descrambler 236 is inputted to the demultiplexer 238, a pre-header verification unit verifies a local TSID field of each inputted TS packet pre-header, and outputs the local TSID field to a corresponding FIFO input unit.

When a 192nd TS packet (including a pre-header) is stored after the FIFO input unit finds a start of a TS packet including a pre-header from the inputted TS and stores the TS packet from a start byte of the packet in an FIFO (the FIFO input unit?), the TS is synchronized with a required operation clock and is outputted as a data block form of the 192nd TS packet (including the pre-header) again.

The packets finally outputted by the demultiplexer 238 pass through a multiplexing process and a descrambling process, and packet timing is jittered. In particular, when timing of the packet including PCR information is jittered, PCR jitter occurs.

Since a range of jitter permitted by an MPEG is 500 nanosecond (ns), PCR correction is required so that PCR jitter may be in a permitted range. Accordingly, a PCR corrector corrects and outputs a PCR value of the packet including the PCR information from among the finally-outputted packets. Four bytes of the pre-header are deleted here.

When the TS packet including PCR is retrieved, a method of correcting the PCR by the PCR corrector records a local time field value of the pre-header and a counter value received from a timestamp generator, and finds and compares differences of the local time field value of the pre-header in a PCR packet being subsequently retrieved and a counter value in this instance, and each previously-retrieved value.

When a difference of local time fields and a difference of counter values are different from each other, jitter occurs. Therefore, an exemplary embodiment of the present invention finds a difference with respect to a local time difference and the difference of counter values again, and corrects the PCR value using the difference.

An exemplary embodiment of the present invention provides a method of providing a plurality of channels without interference with each other via a process of multiplexing a stream received by the plurality of channels, descrambling the multi-stream, and subsequently demultiplexing the multi-stream using the multi-stream processing apparatus 200 of the set top box in the DCAS, and the method is sequentially described based on a functional aspect of the multi-stream processing apparatus 200 of the set top box in the DCAS.

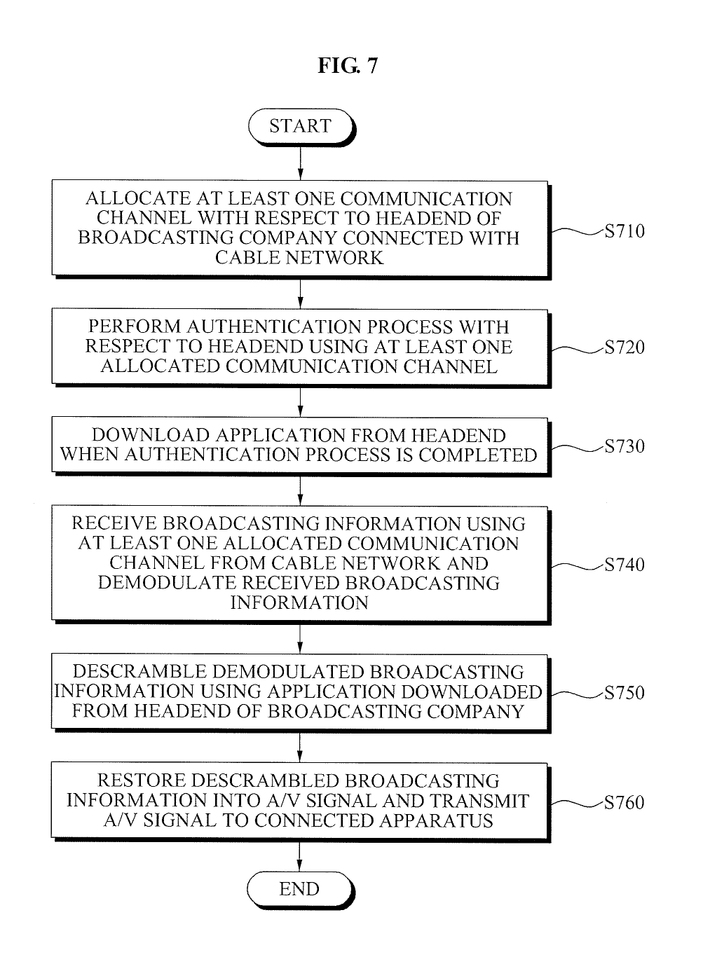

FIG. 7 is a flowchart illustrating a multi-stream processing method of a set top box in a DCAS according to an exemplary embodiment of the present invention.

Since the method includes contents corresponding to a method of using the multi-stream processing apparatus 200 of the set top box in the DCAS, the method includes all functional factors of the multi-stream processing apparatus 200. Accordingly, detailed descriptions thereto are omitted.

In operation S710, the CM 210 first allocates at least one communication channel with respect to a headend of a broadcasting company connected with the cable network 100.

In operation S720, the security module 230 performs an authentication process with respect to the headend using the at least one allocated communication channel.

In operation S730, the security module 230 downloads an application from the headend when the authentication process is completed.

In operation S740, the demodulator 220 receives the broadcasting information from the cable network 100 using the at least one allocated communication channel and demodulates the received broadcasting information.

In operation S750, the method descrambles the demodulated broadcasting information using the application downloaded from the headend of the broadcasting company.

In operation S760, the decoder 240 restores the descrambled broadcasting information into an A/V signal and transmits the A/V signal to a connected apparatus.

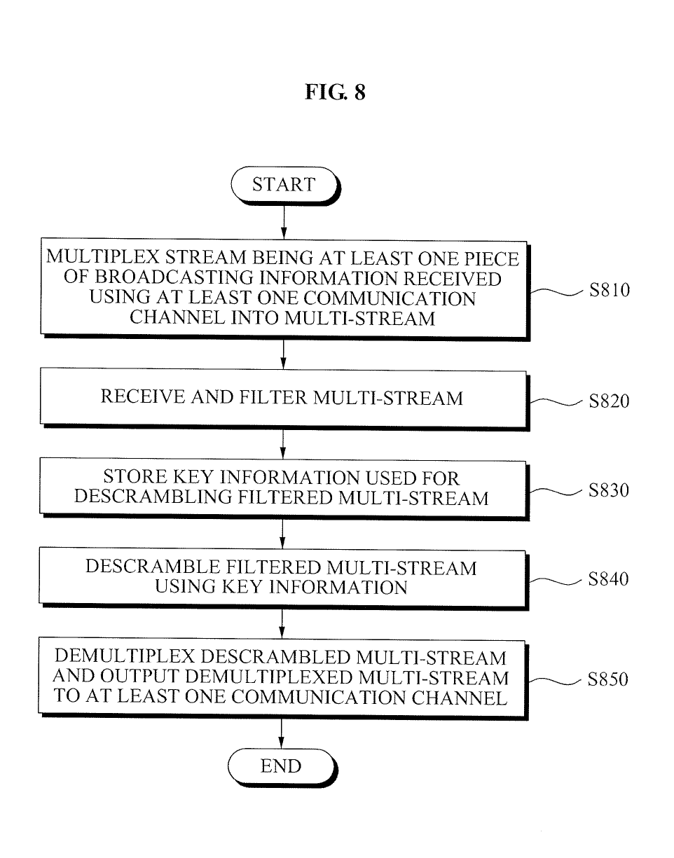

FIG. 8 is a flowchart illustrating a descrambling method according to an exemplary embodiment of the present invention.

The descrambling method according to an exemplary embodiment of the present invention is briefly described with reference to FIG. 8.

In operation S810, the multiplexer 232 multiplexes a stream being at least one piece of the broadcasting information received using the at least one communication channel into a multi-stream.

In operation S810, the at least one received stream is multiplexed using a pre-header attachment scheme.

In operation S820, the broadcasting information filter 234 receives and filters the multi-stream.

In operation S830, the key memory 235 stores key information used for descrambling the filtered multi-stream.

In operation S840, the descrambler 236 descrambles the filtered multi-stream using the key information.

In operation S850, the demultiplexer 238 demultiplexes the descrambled multi-stream and outputs the demultiplexed multi-stream to the at least one communication channel.

In operation S850, the descrambled multi-stream is demultiplexed using a PCR correction scheme.

The above-described exemplary embodiments according to the present invention may be recorded in computer-readable media including program instructions to implement various operations embodied by a computer. The media may also include, alone or in combination with the program instructions, data files, data structures, and the like. The media and program instructions may be those specially designed and constructed for the purposes of the present invention, or they may be of the kind well-known and available to those having skill in the computer software arts. Examples of computer-readable media include magnetic media such as hard disks, floppy disks, and magnetic tape; optical media such as CD ROM disks and DVD; magneto-optical media such as optical disks; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be configured to act as one or more software modules in order to perform the operations of the above-described embodiments of the present invention.

According to the present invention, there is provided a multi-stream processing method and apparatus of a set top box in a DCAS which enables the set top box supporting the DCAS in a cable broadcasting system to simultaneously process a plurality of fee-based channels.

Also, according to the present invention, there is provided a multi-stream processing method using a security module installed in a set top box.

Also, according to the present invention, there is provided a multi-stream processing method and apparatus of a set top box in a DCAS which can multiplex a plurality of channels inputted for supporting a multi-channel processing application, generate a single multi-stream, demultiplex the processed multi-stream, and output the demultiplexed multi-stream to each channel in addition to a function of descrambling and restoring broadcasting information using a TP.

Although a few exemplary embodiments of the present invention have been shown and described, the present invention is not limited to the described exemplary embodiments. Instead, it would be appreciated by those skilled in the art that changes may be made to these exemplary embodiments without departing from the principles and spirit of the invention, the scope of which is defined by the claims and their equivalents.

What is claimed is:

1. A multi-stream processing apparatus of a set top box in a Downloadable Conditional Access System (DCAS), the apparatus comprising:
a security module to convert demodulated broadcasting information into a multiplexed single stream using an application downloaded from a headend, to descramble the single stream, and to reconvert the descrambled single stream into a demultiplexed multi-stream; and
at least one decoder to restore the descrambled broadcasting information into an Audio/Video (A/V) signal and to transmit the A/V signal to a connected apparatus.

2. The apparatus of claim 1, further comprising:
a cable modem (CM) to allocate at least one communication channel with respect to the headend of the broadcasting company connected with a cable network;
a demodulator to receive the broadcasting information from the cable network using the at least one allocated communication channel and to demodulate the received broadcasting information; and
a software module to control the CM, the security module, the demodulator, and the at least one decoder, and to perform routing of information.

3. The apparatus of claim 1, wherein the security module performs an authentication process with respect to the headend using the at least one allocated communication channel, and downloads the application from the headend when the authentication process is completed.

4. The apparatus of claim 1, wherein the security module comprises:
a Transport Processor (TP) module to descramble the demodulated broadcasting information using the downloaded application; and
a Secure Micro (SM) module to provide the TP module with at least one of descrambling key information, a scrambling algorithm, and initialization information.

5. The apparatus of claim 1, wherein the TP module comprises:
a multiplexer to multiplex the single stream being at least one piece of the broadcasting information received using at least one communication channel into the multi-stream;
a broadcasting information filter to receive and filter the multi-stream;
a key memory to store key information used for descrambling the filtered multi-stream;
at least one descrambler to descramble the filtered multi-stream using the key information; and
a demultiplexer to demultiplex the descrambled multi-stream and to output the demultiplexed multi-stream to the at least one communication channel.

6. The apparatus of claim 5, wherein the TP module further comprises:
a descrambling controller to control the multiplexer, the broadcasting information filter, the key memory, the at least one descrambler, and the demultiplexer, and to communicate with a software module.

7. The apparatus of claim 6, wherein, when descrambling initialization information is transmitted from the software module, the descrambling controller analyzes the initialization information, and selects and initializes any one of the at least one descrambler.

8. The apparatus of claim 1, wherein the multi-stream includes broadcasting-related information, and
the broadcasting-related information includes a transmission flow packet including a specific program information table.

9. The apparatus of claim 5, wherein the TP module further comprises:
a switch to transmit the multi-stream from the broadcasting information filter to any one of the at least one descrambler, and to transmit the descrambled multi-stream from the selected descrambler to the demultiplexer.

10. The apparatus of claim 1, further comprising:
a storage unit to store the descrambled broadcasting information.

11. The apparatus of claim 1, wherein the security module multiplexes at least one received stream using a pre-header attachment scheme.

12. The apparatus of claim 1, wherein the security module demultiplexes the descrambled multi-stream using a Packet Clock Reference (PCR) correction scheme.

13. A multi-stream processing method of a set top box in a DCAS, the method comprising:
allocating at least one communication channel with respect to a headend connected with a cable network;
performing an authentication process with respect to the headend using the at least one allocated communication channel;
downloading an application from the headend when the authentication process is completed;
receiving broadcasting information from the cable network using the at least one allocated communication channel and demodulating the received broadcasting information;
descrambling the demodulated broadcasting information using the application downloaded from the headend of the broadcasting company; and
restoring the descrambled broadcasting information into an A/V signal and transmitting the A/V signal to a connected apparatus.

14. The method of claim 13, wherein the descrambling comprises:
multiplexing a stream being at least one piece of the broadcasting information received using the at least one communication channel into a multi-stream;
receiving and filtering the multi-stream;
storing key information used for descrambling the filtered multi-stream;
descrambling the filtered multi-stream using the key information; and
demultiplexing the descrambled multi-stream and outputting the demultiplexed multi-stream to the at least one communication channel.

15. The method of claim 14, wherein the multiplexing multiplexes the at least one received stream using a pre-header attachment scheme.

16. The method of claim 14, wherein the demultiplexing and outputting demultiplexes the descrambled multi-stream using a PCR correction scheme.
